(19) United States
(12) Patent Application Publication
(10) Pub. No.: US 2010/0291367 A1
(43) Pub. Date: Nov. 18, 2010

(54) LINING

(75) Inventor: Edward Kosior, London (GB)

Correspondence Address: BARLOW, JOSEPHS & HOLMES, LTD., 101 DYER STREET, 5TH FLOOR, PROVIDENCE, RI, 02903, US

(73) Assignee: NEXTEK LIMITED, London (GB)

(21) Appl. No.: 12/663,717

(22) PCT Filed: Jun. 9, 2008
(86) PCT No.: PCT/GB2008/001972

§ 371 Date: May 26, 2010

(30) Foreign Application Priority Data
Jun. 9, 2007 (GB) 0711131.3
Feb. 15, 2008 (GB) 0802835.9

(51) Int. Cl. B32B 25/08; C08L 77/00; B32B 27/30; C08L 23/10; C08L 27/06; B32B 27/32; B32B 27/36; B32B 27/34; C08L 23/06; C08L 9/00; C08L 11/00; C08L 67/06

(52) U.S. Cl. 428/220; 428/521; 428/522; 428/523; 524/1; 524/552; 524/563; 524/567; 524/570; 524/571; 524/574; 524/585; 525/55; 525/418; 525/420

(57) ABSTRACT

The present disclosure relates to a polymeric composite material comprising at least one polymer material and a quantity of an adhesive component, wherein the adhesive component comprises a reinforcement material, for use as a lining, especially in sealing leaks in pipes. A tool for the installation of the lining is also provided.

The present invention relates to a polymeric composite material for use as a lining, especially for use in sealing leaks in pipes, together with a tool for the installation of the lining.

Leaking pipes, particularly leaking underground sewerage and water pipes are a major problem in the UK. Leaking water pipes result in the waste of a significant amount of water [3649 mega litres per day in 2003-04 (OFWAT)]. Leaking sewerage pipes cause contamination of ground water, and during heavy rainfalls, allow large quantities of clear water to enter sewerage treatment plants thus resulting in the flushing of untreated sewerage into the environment.

The solutions to these problems currently include pipe replacement, but this is a costly long term solution. An alternative, more instant solution has been to line leaking pipes with a water impervious material to seal a rupture in the pipe and thereby preventing the egress of water and sewerage.

Currently available pipe linings include linings which are pulled into position. These are intended for whole pipe line replacement. However, these can be difficult to position as they are pulled through an existing pipe and the pipe is often damaged further during their installation.

Other linings can be cured once positioned such that a robust lining is obtained. Although these linings can be installed with a reduced diameter and thereby aid installation, they are composed of epoxy or styrene based resins which can emit toxic substances into the water supply during curing.

Pipe bursting is also a commonly used replacement technique. Existing pipes are broken internally and a new pipe is pulled into the place of the old pipe. This is a costly and time consuming approach to replacement.

A still further approach is the spiral relining of pipes. A plastic strip is welded to the inside of a pipe to seal a rupture in the pipe and effectively becomes the wall of the pipe at the rupture site. Due to the need to weld, this approach is limited to larger diameter pipes of 1 metre or more.

Therefore, it is desirable to provide a material for a lining which is sufficiently flexible in order that its shape can be deformed to facilitate installation inside an existing pipe and yet have sufficient stiffness properties to perform as a self-supporting pipe lining, and which can be used inside smaller diameter pipes. The present invention addresses these issues.

Thus, according to the present invention there is provided a polymeric composite material comprising at least one polymer material and a quantity of an adhesive component, wherein the adhesive component comprises a reinforcement material.

According to one embodiment of the invention, the reinforcement material comprises glass fibre, typically a thin layer, such as a lightweight (approx. 75 to 90 g/m²) fibreglass mat. Alternatively, the reinforcement material may be particulate filler such as silica or carbon black, or may be a reinforcement material selected from carbon fibre, Kevlar, nylon, or polyester. According to one embodiment of the invention, the reinforcement material is only incorporated into the adhesive in the region of any cracks in the pipes.

The polymer material has elastomeric properties, i.e. it has a high strain to failure such that it does not fail under stretching forces.

Suitable polymer materials include, but are not limited to, any of the following either alone or in combination: low density polyethylene (LDPE), linear low density polyethylene (LLDPE), poly(ethylene-co-vinyl acetate) (EVA), high density polyethylene (HDPE), plasticised polyvinyl chloride (PVC), ethylene-propylene copolymers, ethylene-propylene diene monomer (EPDM), polyisoprene, polychlorprene, polybutadiene, and copolymers of poly butadiene such as styrene or acrylonitrile, or other polymers with similar chemical and physical properties.

The adhesive component may be any adhesive which satisfactorily binds the polymer material to the pipe, but typically comprises epoxy groups, polyester, silicone or silicate-isocyanate.

Optionally, the polymeric composite material may comprise at least one filler having a mean particle size distribution in the range of from about 10 nm to about 600 microns.

The filler preferably has a mean particle size distribution in the range of from about 10 nm to about 500 microns, or from about 10 nm to about 400 microns. The surface chemistry of the filler particles may be modified via oxidation or other chemical processes as required in order to modify the polarity of the filler. Matching polarities result in an increase in the physical wetting of the filler particles by the polymer during manufacture of the composite. Ultimately, this improves adhesion between the polymer material and filler.

Preferably the filler is present in a range of particle sizes. This assists with interstitial packing of the filler in order to reach higher filler loadings without detriment to the physical properties of the composite.

The particles are typically present in two discrete mean sizes, size A and size B, and these in turn are present in a ratio in the range of from about 5:1 to about 1:5, or about 4:1 to about 1:4. For example, the composite may comprise 5 parts of filler with a mean particle size of about 500 microns and 1 part of filler with a mean particle size of about 100 microns.

The polymer material and the filler material are typically present in the polymeric composite material in a ratio of about 5:1 or about 4:1.

Suitable fillers include any non-reactive particles, including but not limited to inorganic fillers including clay, chalk, calcium carbonate, carbon black, silica or barites, although typically the filler comprises rubber. According to one embodiment of the invention, the rubber comprises an amount of recycled rubber such as rubber crumb from car tyres or from other sources of rubber such as conveyor belts.

The rubber crumb may be prepared, for example, by mechanical grinding of waste car tyres to the specified particle size range. The grinding is such that the surface of the ground particles is uneven and rough. This provides ground particles of a relatively high surface area. The material of the invention typically has a rubber granulate content of up to about 50%. A rubber granulate content of from about 10% or 12.5% can be used, or even as little as about 0.5%.

Typically, the polymer material and the filler are present in the composite material in a ratio in the range about 99:1 to about 50:50 or even 30:70.

According to a further aspect of the invention there is provided a self-supporting lining for a pipe, the lining being suitable for location inside a pipe. According to one embodiment, the lining comprises a polymeric composite material comprising at least one polymer material and a quantity of an adhesive component, wherein the adhesive component comprises a reinforcement material as described above.

According to another embodiment, the lining can be dimensioned to form a water tight seal inside a pipe, thereby preventing unwanted egress and ingress of water. The lining is particularly useful for lining private sewer lines which are typically about 100 mm in diameter, although sewer lines of up to about 600 mm in diameter may be lined using the lining of the invention.

Many pipes do not have a smooth inner surface or do not have true circular cross-sections, the inner surface instead containing many grooves or indentations. As the polymeric composite material is provided as a perfect circle, it may not contact the entire inner surface of the pipe due to the grooves or indentations. This may allow some water into the pipe through cracks in any areas where the lining is not in contact with the inner surface of the pipe. If enough water can get into the pipe, it may cause a deformity in the lining which can extend along its full length.

It is the use of the adhesive component which helps to provide even better protection against leaks, playing a dual role. As well as helping to hold the lining even more securely in place as it forms a strong bond between the lining and the pipe, the adhesive component strengthens the lining against the ingress of water and deformation by filling any gaps or cracks which may be present in the inner wall of the pipe to be sealed.

Once cured in the pipe, the adhesive hardens, increasing the effective rigidity of the exterior of the lining approximately 10-fold, while still retaining the flexibility of the polymeric composite material.

Incorporating the reinforcement material into the adhesive in the region of any known cracks stiffens the lining even further and increases resistance still more to deformation caused by external water pressure due to water ingress though the cracks.

A further benefit of the invention is that it reduces the quantity of adhesive component required in comparison with existing pipe sealing techniques. Many adhesives which are used are reactive or toxic compositions and present handling problems. Current pipe repair systems use upwards of 500 g of adhesive resin. The present invention only requires about 45 g, representing more than an 11-fold reduction, which is beneficial both to the environment and the people who have to handle it.

The structure of the lining renders it sufficiently flexible yet also sufficiently robust to perform as a pipe lining. The modulus of the lining may be in the range of from about 1 MPa to about 3 MPa, and the polymeric composite material is preferably able to achieve about 10% strain to facilitate installation without being damaged. However, adjusting the thickness of the lining enables it to work outside this modulus range.

The flexibility of the lining permits easy and fast installation inside short or long lengths of pipes. This enables low cost solutions to leaking pipes to be developed.

As the circumference of the lining can be deformed to reduce its diameter, it can be installed inside a pipe without causing further damage to the pipe. Furthermore, once the deformation is removed and the original circumference of the lining is retained, the ruptured pipe is immediately sealed. Therefore, no curing is required and no toxic emissions are generated.

The lining of the invention is preferably produced by extrusion. The composite material can be extruded into an annular tube and cooled to form an annular shape.

The internal and/or external surface of the lining may optionally be coated with a further polymer material. Such a coating improves the sealing of the lining allowing better flow of fluids therethrough.

Suitable polymers for coating the lining include, but are not limited to, low density polyethylene, linear low density polyethylene, poly(ethylene-co-vinyl acetate), high density polyethylene, plasticised polyvinyl chloride), ethylene-propylene copolymers, ethylene-propylene diene monomer (EPDM), polyisoprene, polychlorprene, polybutadiene, and copolymers of poly butadiene such as styrene or acrylonitrile, or other polymers with similar chemical and physical properties.

The lining preferably has a wall thickness in the range of from about 1 to about 5 mm, more preferably in the range of from about 2 to about 3 mm, and has stiffness in the range of from about 1 to about 5 MPa. This ensures that the lining is self-supporting once positioned inside the pipe.

The lining may be installed inside a pipe by means of special jigs or by inversion with compressed air or water.

That said, the present invention also provides a tool for the installation of the lining described herein.

According to a further aspect of the present invention there is provided a tool comprising a body, said body having a first section, a second section being of reduced dimensions relative to the first section, said first and second sections optionally having a third section located therebetween, said tool having a pivotally mounted clamping device, said device comprising a tensioned elongate member and a release mechanism.

The body of the tool may be at least partially hollow. Alternatively, the body of the tool may be in the form of a wire cage such that much of its structure is open.

The first section of the body of the tool may be of any suitable cross-sectional shape in order that it can be pushed into a pipe. Since most pipes are cylindrical the first section of the body of the tool is typically circular in cross-section.

The leading end of the first section may be provided with a tapered section to facilitate passage through the pipe. The tapered section may be any suitable shape, for example ovoid, spherical or conical.

The second section of the body of the tool has reduced dimensions relative to the first section. Thus, the diameter of the second section may be reduced relative to the diameter of the first section.

The second section of the body of the tool may have a different cross-sectional shape to that of the first section, for example it may be semi-circular such that a half-pipe configuration is exhibited.

The surface of the second section of the body may be textured so as to aid retention of the lining in the tool once clamped. The section may be textured by way of e.g. grooves or indentations.

The lining fits over the second section of the body of the tool to form a sleeve.

The extent to which the lining forms a sleeve around said body depends upon the length of the lining. That is, all or part of the lining may form a sleeve over the body of the tool.

The first and second sections may have a third section therebetween. The third section provides a transition between the first section and the second reduced dimension section. Whilst a third section is not essential it is preferred.

The clamping device may be pivotally mounted inside the first section of the body of the tool. Preferably, said device is mounted up on a member that extends laterally across the first section.

The elongate member of the clamping device is further attached to the body of the tool by way of a tensioned recoil device. Preferably, the recoil device is a spring. The recoil device facilitates engagement of the lining with the tool and its removal therefrom.

The elongate member may occupy a first resting position, a second engagement position whereby the elongate member secures the lining around the body of the tool and a third disengagement position whereby the tension of the elongate member is removed in order that the lining can be removed from the tool.

The clamping device may be constructed from any suitable material, such as plastic or metal.

The release mechanism of the tool may be any suitable mechanism to bring about actuation of the pivot in order that the tensioned elongate member of the clamping device is released such that the elongate member disengages the lining.

The release mechanism may be a cord or rod attached to the elongate member near to the pivot. Actuation of the cord or rod results in the pivoting of the elongate member and ultimately its disengagement from the lining.

The tool may be inserted into the pipe using a flexible rod, for example pultruded fibre glass. The rod may comprise a plurality of lengths each of which may be configured so that the length can be easily and quickly extended by way of a screw or bayonet type fitting. The rod is marked in units of length so that the lining can be accurately positioned at the exact location in the pipe which requires repair.

Typically, the tool clamps and holds an end of the lining, allowing it to be transported to the exact location in the pipe. The tool partially collapses the end of the lining, thereby reducing its diameter to aid in its installation. Once the exact location for the lining has been reached, the tool unclamps the lining and releases it. The tool is then moved forwards to clear the clamp from the lining, and the clamp retracts back into the cross-sectional profile of the tool to permit the tool to be withdrawn back through the lining.

Removal of the tool restores the shape of the lining from the partially collapsed shape to a fully circular cross-section to increase the diameter of the lining and thereby sealing the pipe.

According to a further aspect of the present invention there is provided a method for sealing a ruptured pipe comprising the steps of engaging a lining with a body of a tool as hereinbefore described, inserting said tool into a pipe, disengaging the lining from the tool and removing the tool from the pipe such that the lining is retained within the pipe.

The tool may also be used to clamp a reinforcing or support component that can then be inserted into the pipe until it is positioned inside the lining. The release of the clamp will allow the support component to be expanded against the wall of the lining by either stored elastic energy or by the action of the circular section of the tool being retracted through the lining or by the action of the body of the tool prior to disengagement from the support component.

Examples of further reinforcement or support components could include, but are not limited to:
a) a coiled sheet of a stiff material comprising materials such as polymers, polymer composites, metals, or other suitable materials. Prior to clamping the sheet is elastically wound to a diameter that would allow easy passage into the lining. When released, the sheet expands until it contacts the inner surface of the lining, thereby supporting the lining from external pressures that might deform it and allow the ingress of external water.
b) a spiralled strip section comprising materials such as polymers, polymer composites, metals, or other suitable materials. Prior to clamping the spiral section is elastically wound to a diameter that would allow easy passage into the lining. When released, the spiral section expands until it contacts the inner surface of the lining, thereby supporting the lining from external pressures that might deform it and allow the ingress of external water.
c) a plastically deformable section comprising materials such as polymers, polymer composites, metals, or other suitable materials. This section may be sheet or mesh like in character. The passage of the tool expands the section into a final diameter and the plastically deformed section then retains this shape permanently.

The tool of the invention enables quick and precise installation of the lining allowing for many such installations to be carried out each day. The lining may be left in place after just 15 minutes, in contrast to a matter of hours for existing cure-in-place systems. This is important, as, for example, over half of London's water pipes are over 100 years old and in need of repair. Using the slower existing systems would therefore require a very long time to accomplish the required repairs.

As an alternative to using the tool of the invention, the lining can be installed in position by using a deflated bag technique commonly used in the plumbing industry.

The method of the invention allows ruptured pipes to be repaired without the need to dig up the pipes.

The polymer composite material and the lining of the invention are also environmentally advantageous as they provide a high-value use for waste car tyres. This is particularly important in view of European laws which now prohibit the dumping of waste tyres in landfill sites. It also has the capacity to reduce the emissions of pipe repair seals due to a large reduction in adhesive resins required (over 90% less), and ten times lower emissions from volatiles and water soluble components are generated. Additionally, an increased use of recycled materials means that the lining has 22.5% less embodied energy compared with those made from non-renewable sources (based on the rubber granulate having approximately 50% of the embodied energy of virgin resins), and the disposal measures currently required for waste car tyres will be significantly reduced due to the higher consumption of tyres to make the invention.

The market for ‘no-dig’ pipe repair systems is around 18,000 pipe repair seals per annum in the UK alone. Each 500 mm seal uses 203 g of rubber granulate. This technology has the potential to use over 3,600 kg of rubber granulate a year in a high-value application for waste tyre rubber.

The invention is also cheap in comparison with existing methods due to the lower cost of the materials, yet the lining of the invention has been proven to achieve the test standard BS EN1610 for infiltration and exfiltration.

Also envisaged within the present invention is that the polymeric composite material can be used in other applications where its elastomeric properties are useful for their flexibility and toughness. Such applications include gaskets, seals, conveyor belt surfaces, abrasion linings, matting, flooring tiles and walkway coverings.

The present invention will now be described further by way of example only and with reference to the following drawings in which:

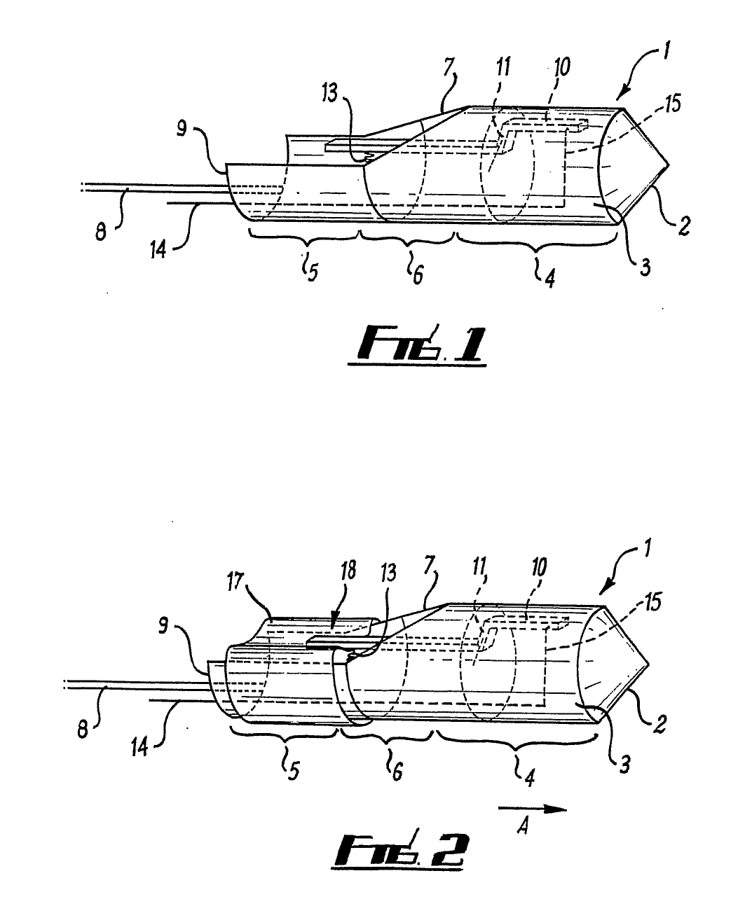

FIG. 1 shows a perspective view of the tool of the present invention.

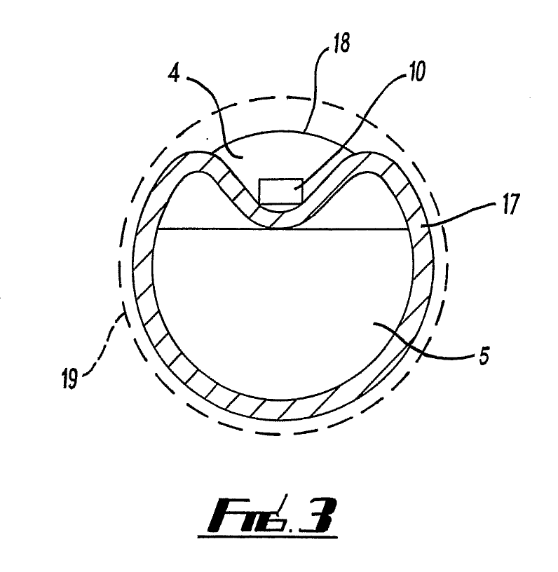

FIG. 2 shows a perspective view of the tool of FIG. 1 showing the lining in position.

FIG. 3 shows an end cross-sectional view of a lining engaged in the tool of the present invention.

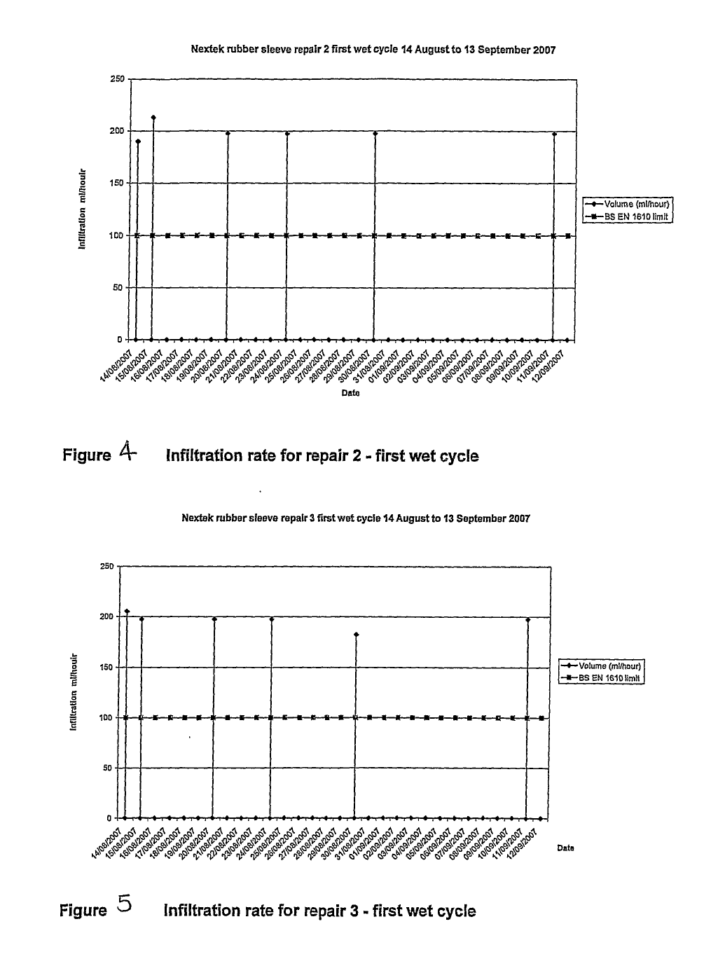

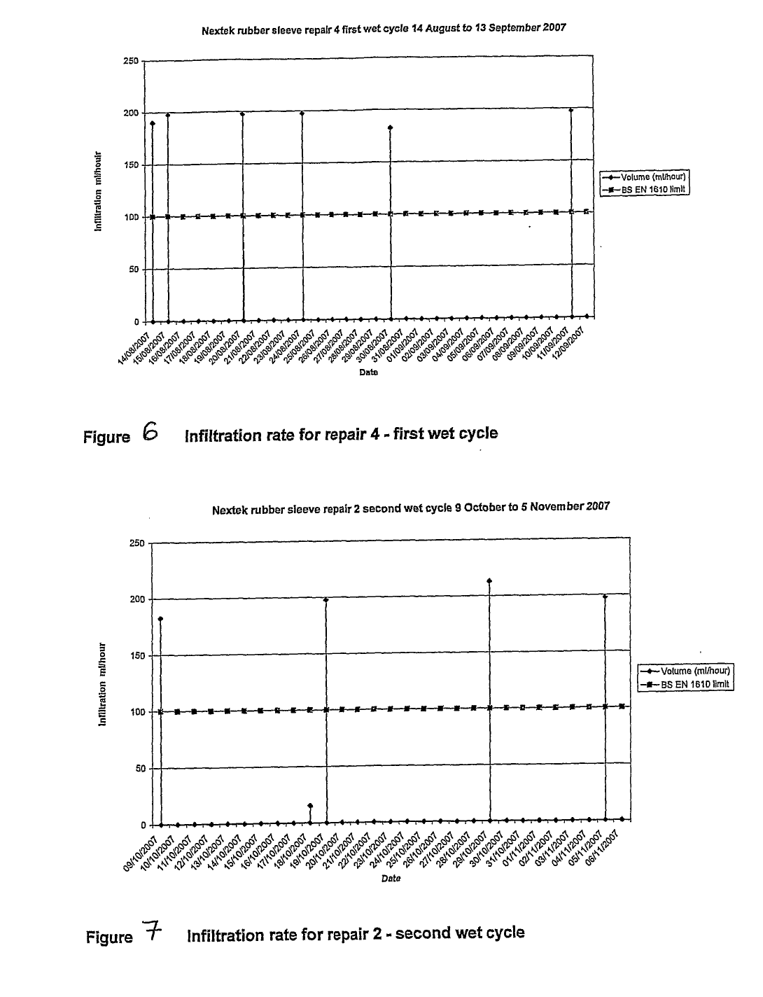

FIGS. 4-6 show the levels of water infiltration through three pipes repaired using the lining of the invention during their first wet cycles.

FIGS. 7-9 show the levels of water infiltration through three pipes repaired using the lining of the invention during their second wet cycles.

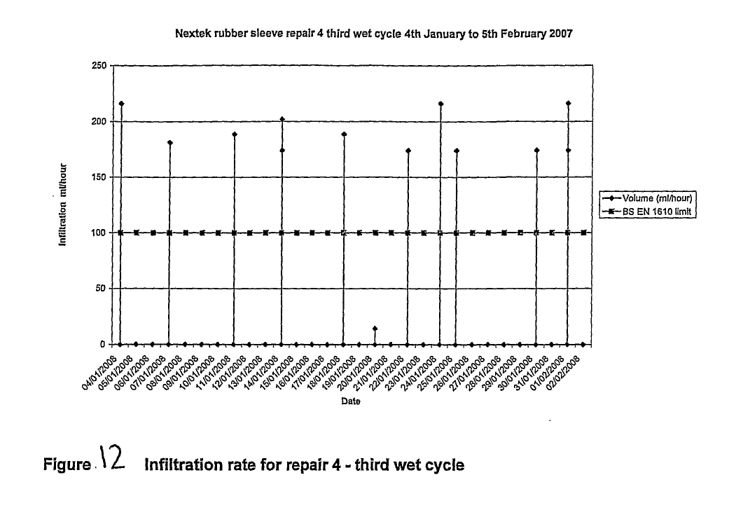

FIGS. 10-12 show the levels of water infiltration through three pipes repaired using the lining of the invention during their third wet cycles.

FIG. 1 shows a tool 1 having a conically shaped leading end 2. The tool comprises a body 3 having first cylindrical section 4 and a second semi-circular section 5. The second section is cut away so as to form an open section. Said first and second sections are interconnected by way of a third section 6 whose upper surface has an inclined configuration 7. The body 3 is provided with a rod 8 which is attached to the trailing end 9 of the body 3. An upper region of the body is provided with an elongate member 10. The elongate member 10 is attached by way of pivot 11 to the cylindrical section 4. FIG. 1 shows the elongate member 10 having a dog leg configuration. The pivot 11 comprises a member extending laterally across the body of the tool. The elongate member 10 is pivoted around the aforesaid lateral member. The elongate member 10 is also attached to the body 3 by way of a spring 13. The elongate member 10 is provided with a release mechanism 14. The release mechanism 14 comprises a cord 15 secured to the elongate member 10 near to the pivot 11. The cord 15 extends through the body 3 and exits said body 3 to the rear of the semi-circular section 5.

FIG. 2 shows the tool of FIG. 1 having a lining 17 located around the semi-circular section 5. The lining 17 is positioned such that the elongate member 10 tensioned by the spring 13 engages the external surface 18 of the lining 17 in order that the circumference of the lining 17 is deformed.

FIG. 3 shows a lining 17 positioned around the body 3 of the tool 1. The lining 17 forms a sleeve over the second section 5 of the body. Part of the lining 17 engages the elongate member 10 such that the elongate member depresses the wall of the lining 17 to deform its circumference. The upper edge 18 of the first section 4 of the body 3 can be seen. The tool 1 having the lining 17 located therearound is shown positioned inside a pipe 19 (shown by way of a dotted line).

In use, the lining 17 is slotted over the end of the second section 4 of the tool 1. Part of the lining 17 is positioned underneath the elongate member 10 to deform the circumference of the lining as shown in FIG. 3. This process can be facilitated by actuating the pivot 11 by pulling the release cord 15. This lifts the elongate member 10 to provide more space for positioning the lining 17. Once in position and if moved the release cord 15 is released and the elongate member 10 falls back towards its original position. The elongate member 10 secures the lining 17 in position around the tool so that it cannot be pulled off the tool. The elongate member retains its position by way of spring 13. The tool 1 is then inserted into a pipe to be repaired in the direction shown by arrow A in FIG. 2. Having carefully measured the location of the damage in the pipe, the tool can be manoeuvred into the correct position by way of the rod 8. The rod 8 is calibrated to aid precise location of the lining.

Once in the correct position the lining 17 is removed from the tool 1 as follows. The release cord 15 is pulled to actuate the pivot 11. Upon actuation of the pivot 11 the elongate member 10 is raised against the tension of the spring 13 once raised the tool 1 is pushed further in the direction shown by arrow A in FIG. 2 until the lining 17 is cleared by the elongate member 10. The lining 17 immediately regains its original shape. The lining 17 is correctly dimensioned to fit securely inside the pipe.

Following clearance of the lining 17, the release cord 15 is released by action of the spring 13. The elongate member 10 regains its original position. The tool is then pulled through the pipe in the reverse direction leaving the lining 17 in place. The tool is dimensioned so that sufficient clearance is provided to allow removal.

### EXAMPLES

An industrial process to manufacture approximately 400 kg of a compound containing about 50% waste tyre rubber granulate (rubber crumb) was carried out. It is important to ensure low shearing in order to avoid the creation of volatiles. Analytical tests using a differential scanning calorimeter (DSC) had also indicated that the rubber compound starts to give off volatiles at approximately 190° C. It was found that the volatilization of the oil extender in the rubber causes foaming within the compound at temperatures over 190° C. and high shear conditions. This results in decreased material viscosity and overall degradation of the final material.

### Trial Manufacturing Conditions

The trial was performed on a compounding Leistritz extruder with a general-purpose screw and an underwater pelletiser unit. The following tables show machine and trial conditions.

MACHINE TEMP CONDITIONS (° C.)

| Z1 | Z2 | Z3 | Z4 | Z5 | Z6 | Z7 | Z8 |
|---|---|---|---|---|---|---|---|
| 150 | 145 | 145 | 145 | 145 | 145 | 145 | 145 |

MACHINE PARAMETERS

| ADPT. | BODY | DIE | SCREW | THROUGHPUT | LOAD | WATER | |
|---|---|---|---|---|---|---|---|
| temp | temp | temp | rpm | Kg/hr | (%) | temp | rpm |
| 150 | 160 | 170 | 140 | 250 | 70-75 | 50-60 | 2020 |

### Rheological Properties of Compound

Initial rheological testing was performed on manufactured pellets. It was observed that as the residence time within the melt flow index (MFI) tester had increased, the compound began to release volatiles and started to show signs of foaming. This is clearly seen in the following MFI table.

| | MFI RESULTS |
|---|---|
| | (5 kg, 190° C.) |
| 1^{st} Sample | 2.62 |
| 2^{nd} Sample | 2.68 |
| 3^{rd} Sample | 2.98 |
| 4^{th} Sample | 3.22 |

### Conclusions

A 50% rubber crumb-based compound was successfully synthesised. The successful compound blend consisted of the following material make-up:

| MATERIAL | % OF BLEND |
|---|---|
| Rubber crumb | 50% |
| EVA (2803) | 37.5% |
| r-LDPE | 12.5% |

Material development and testing were conducted on a Brabender mixing extruder using a slit die. The screw used in the extrusion was a zero-compression screw that provides a low-shear processing environment. The purpose was to evaluate the effects of extrusion speed and ethylene vinyl acetate (EVA) blends on the extrusion surface characteristics of the waste tyre rubber granulate compound:

The following processes were undertaken:
Process 1—50% rubber compound:50% EVA 2803
Process 2—50% rubber compound:50% EVA 2805
Process 3—90% rubber compound:10% EVA 2805
Process 4—95% rubber compound:5% EVA 2805
Process 5—94% rubber compound:5% EVA 2805:1% Hoechst Hostalub H12 PE520 (lubricant)

The results of each of these extrusion processes are given in detail below.

Process 1—50% Rubber Compound:50% EVA 28003

The rubber compound was blended 50:50 with EVATANE 2803 (Ethylene Vinyl Acetate (EVA)). This blend was then extruded (at 30/60/100 and 150 rpm). The extruded strips showed a smoother and a glossier surface finish compared to a 100% rubber compound. Material extruded at lower speeds (30/60 rpm) did not show any signs of degradation. Material extruded at 100 and 150 rpm showed some signs of degradation in the form of increasing levels of bubbles, rougher external surface finish and lower melt strength.

Process 2—50% Rubber Compound:50% EVA 2805

The rubber compound was blended 50:50 with EVA 2805 and the blend extruded at 30/60/100/150 and 180 rpm. The extruded material was quite sticky at all speeds, but showed very good melt strength and very good surface finish. There was almost no difference in the surface characteristics of samples extruded at 30 rpm and 150 rpm. Due to this significant improvement in melt strength and surface finish, three more processes were conducted (Processes 3-5). These were run with reduced amounts of EVA 2805 to reduce the material stickiness.

Process 3—90% Rubber Compound:10% EVA 2805

In this process the rubber compound was blended with 10% EVA2805. The blend was extruded at 30/60/100/150 and 180 rpm. Bubbles started to form at 150 rpm and were more prevalent in the sample extruded at 180 rpm. Material extruded at lower screw speeds did not show any bubbles or any other form of degradation. All samples showed very good surface characteristics and samples extruded at 150/180 rpm were only marginally rougher then samples extruded at 30/60/100 rpm. The 10% of EVA 2805 helped improve processability in comparison with Process 2 and the lower addition rate reduced the stickiness of the extruded material.

Process 4—95% Rubber Compound:5% EVA 2805

In this process the rubber compound was blended with 5% of EVA 2805. The blend was extruded at 30/60/100/150 and 180 rpm. Bubbles started to form at 150 rpm and were more prevalent in the sample extruded at 180 rpm. Material extruded at lower screw speeds did not show bubbles or any other form of degradation. All samples showed very good surface characteristics and samples extruded at 150/180 rpm were only marginally rougher then samples extruded at 30/60/100 rpm. The 5% addition of EVA 2805 helped improve processability and the surface characteristics of the extruded samples were as good as those found in samples with a 10% addition rate (Process 3).

Process 5—94% Rubber Compound:5% EVA 2805:1% Hoechst Hostalub H12 PE520

The last process included the addition of 5% EVA 2805 and 1% of the Hostalub lubricant. The reason for this was to combine the actions of the lubricant and the higher flow rate of the EVA 2805 and evaluate the combine effect on the rubber compound processability. The blend was extruded at 30/60/100/150 and 180 rpm. Samples extruded at 30/60 rpm had a smooth surface finish and no bubble formation or other type of material degradation. Bubbles began to form at 100 rpm and extruded samples at higher speeds (150/180 rpm) showed increasingly rougher surface finishes with higher levels of bubbles within the extrudate.

A number of findings were determined:
Screw design is of importance in successfully extruding the rubber compound. Using a zero-compression screw brought large improvements in performance. This was due to a reduction in shear heating which meant that degradation and foaming did not occur until very high speeds were reached.
Material degradation, bubble formation (foaming) and surface finish are directly linked to screw speed. Increased screw speed resulted in increased material degradation, indicated by bubble formation and the loss of melt strength. High shear conditions associated with high screw speeds are therefore directly responsible for material degradation. It was found that extruding material blends at 30 to 60 rpm generally gave the best surface finish and the highest melt strength. Material blends extruded at these speeds also showed no signs of material degradation. The typical onset of bubble formation for blended materials was at 100 rpm.
The best processing results were obtained when Hostalub PE lubricant and 5% addition of higher-flow EVA grade (2805) was used. Blends that contained these modifiers showed improved surface characteristics and lower material degradation due to the delayed onset of rubber degradation within the extruder. These blends did not begin to show bubble formation (foaming) until the screw speeds reached 150 rpm. This was a significant improvement compared to the reference material (100% rubber compound) and other blends tried.

### Extrusion of Optimised Rubber Compound Pipe Seals

A further extrusion was performed using a modified zero-compression screw that had been especially designed to reduce material degradation. A new vacuum calibrator was also used during the extrusion trials.

### Extrusion Results

The extrusion saw a major improvement due to the improved rubber compound formulation. The change to a zero-compression extrusion screw also permitted the material to be extruded without degradation. Overall, the material extruded well and there was no sign of foaming, smoke or degradation of the compound. The extrusion began by purging and running through the machine 100% LDPE resin. The LDPE was replaced with EVA once the pipe extrusion vacuum system was stable. The rubber compound was then added in increasing concentrations. This was done to ensure that the pipe extrusion remained stable.

### Extrusion 1—5:1 EVA/Rubber Compound Blend

The first extrusion included a 5:1 EVA/rubber compound blend. This blend extruded very well and proved to be very stable during extrusion and pipe haul-off. This blend also allowed wall thickness optimisation and the samples extruded were approximately 4 mm thick. No material degradation was observed and the external surface finish was glossy and smooth.

### Extrusion 2—4:1 EVA/Rubber Compound Blend

In the second extrusion the amount of rubber compound was increased and the ratio of EVA to the rubber compound was 4:1. This blend also extruded well and physical and visual examination revealed no sign of material degradation, foaming or smoke due to degradation. Overall the pipe extruded well but the outside surface had a slightly rougher finish.

### Conclusions

Use of the zero-compression screw significantly improved the extrusion of this rubber compound, making it technically feasible to extrude the linings in the form of a pipe and then cut them to size. The most successful blends with EVA/rubber compound were 5:1 and 4:1, and both of these blends extruded pipes with smooth surfaces and even wall thickness. This means that the final waste tyre rubber granulate content present in the extruded pipe linings is 10% and 12.5% respectively.

### Initial Water Ingress Trials

A sample PVC pipe was prepared. A hole was drilled into the PVC pipe to represent a crack in the pipe; a hose was then tapped into the pipe wall and a water pressure pump connected to the pipe. A pressure gauge was also connected to measure the pressure at which the linings started to leak.

A number of ‘clear’ EVA linings were manufactured specifically for the lining testing to permit observation of the ‘travel’ of water between the lining and the pipe wall.

The test results using the clear EVA clearly showed that linings which were manufactured to the exact diameter of the pipe inner diameter leaked water. A decision was therefore made to repeat these tests with actual rubber linings, which were stiffer and made slightly larger to put the lining under compression from the pipe walls.

It was found that if the rubber linings form a tight enough seal with the pipe they resist the water pressure very well and do not result in significant water leakage. There is some water leakage after a period of time; however, this was attributed to the slight grooves seen in the PVC pipe. These grooves are due to the extrusion process and water will eventually find a way through.

### Above-Ground/Underground Installations of the Rubber Pipe Seals

The rubber pipe linings were taken for installation in special above-ground and underground pipe testing pits. Results from these installations were positive and demonstrated that the invention can be used in real sewer pipe's.

### Above-Ground Installation Trials

The testing method included the set-up of 3×1.5 m of clay pipe. If necessary this could be replicated using a 5×1.5 m set-up, as that would cover a distance of 7.5 m—the typical length of a drainage pipe leading from a house to the main 150 mm sewer pipe.

Initial installations were performed using the fitting tool of the invention, or a ‘drain stopper airbag’. This device allowed the linings to be collapsed over the deflated airbag then inserted into position inside the pipe as the bag was inflated.

### Installation Results

The installations were very successful; the entire installation took less than 3 minutes using the deflated airbag technique. If the installation technique works well above ground it will work equally well underground. Underground installation was simulated using bent rods and proved equally successful.

### Water Sealing Improvements

A process was performed to examine improvements to the sealing properties of the linings. The lining was installed in a pipe with a layer of epoxy-based adhesive on the outside surface of the lining. Due to the compression of the lining against the inner wall of the pipe, a layer of adhesive helps to hold the lining in place and form a barrier against leakage. A clear EVA lining was used to show the performance of the adhesive inside the pipe.

These processes clearly indicate that the adhesive forms a very uniform barrier layer once installed within the pipe. This adhesive barrier increases the sealing properties of the lining significantly. A further advantage is that the adhesive also helps to hold the linings in place as it forms a very good bond between the lining and the clay pipe itself. The use of the adhesive does not present any installation difficulties.

### Short-Term Hydrostatic Pressure Tests

The objective of the hydrostatic pressure tests was to investigate the leak tightness of the lining under both external and internal hydrostatic water pressure in accordance with the short-term hydrostatic test to a maximum pressure of 5 m head. The key test parameter was to pass the 5 m applied head pressure during infiltration tests, as that is a requirement of European Standard EN1610. Four linings for infiltration and three linings for exfiltration were tested. The test procedure is based on the requirements of BS EN1610—the primary British standard relating to sewer pipe sealing systems.

### Preparation of Pipe

A 1.8 m length of 100 mm diameter clay pipe was used for each test sample. A 60 mm by 20 mm slot was cut at the centre of each pipe to simulate a typical pipe crack. The outside of the clay pipe was coated with varnish to prevent water permeation through the pipe wall.

### Test Rig Assembly

The hydrostatic test rigs were designed and constructed to allow external water pressure to be applied to the repair via the pipe defect. The pipe was positioned so that the defect was at the centre of the 80 nun flange joint. The flange was sealed with a blanking plate which had inlet and outlet valves; these enabled water to be pumped into the annulus between the pipe and the endplate. The pressure was applied to the test assembly via a water column. The level in the water column was maintained by a pump, and the level was adjustable at 1, 2.5 or 5 m. Three patch repairs were prepared using the 2.5 mm wall thickness product. Repairs 1 and 2 were installed under no hydraulic head; repair 3 was installed against a 1 m hydraulic head.

### Leakage Failure Criteria

The aim of these tests was to determine whether the linings could prevent infiltration of groundwater through the defective clay pipe. For a 100 mm pipe the ‘allowable leakage’ for new sewers is less than 0.5 litres per 30 minute period. For the 100 mm pipes used for this installation the allowable leakage is 25 ml per 30 minutes based upon a lining length of 500 mm.

The procedure for testing for leak-tightness for both exfiltration and infiltration was as follows:
The test rig was pressured to 1 m head for a period of 2 hours.
Water loss from the rig was collected and measured for 30 minutes.
The pressure was increased to 2.5 m and allowed to stabilise for 15 minutes.
Water loss from the rig was collected and measured for 30 minutes.
The pressure was increased to 5 m and allowed to stabilise for 15 minutes.
Water loss from the rig was collected and measured for 30 minutes.
The calculation for 10 mm diameter pipes is: 0.51 (litres)×0.5 m (length of repair)×0.1 m (pipe diameter in metres)=0.0251 or 25 ml per 30 minutes.

### Hydrostatic Exfiltration Test Results

The exfiltration of the sealed sewerage pipes was tested over a period of 30 minutes. Repairs 1 to 4 were reconfigured so that exfiltration could be measured. End stoppers were placed at either end of the pipe and restrained in order to withstand applied pressure during the test. The pipe assembly was placed on a slight incline and filled with water. The water was introduced through a central port in the stopper from the lowered end of the pipe; the air displaced was released via a bleed valve on the stopper at the raised end of the pipe. Once the pipe was full, the bleed valve was closed and the pipe pressurised.

The results are shown in the table below. Repair seal No. 1 was not initially tested as the lining was thought not to have been installed properly into the pipe for testing. However later analysis indicated that this lining would most certainly have passed the exfiltration tests as it passed all infiltration tests even under 5 m head pressure. As can be seen in the table, all three linings passed the exfiltration test. The lining therefore provides excellent sealing properties against leakage out of the pipes.

| | Seal wall | | | Water leakage | | Allowable | |
|---|---|---|---|---|---|---|---|
| Repair | thickness | Fibreglass | Pressure | measurement | Duration | infiltration | Pass/ |
| No. | (mm) | patch used | (m) | (ml) | (minutes) | (ml) | Fail |
| 2 | 2.5 | Yes | 5 | 0 | 30 | 25* | Pass |
| 3 | 2.5 | Yes | 5 | 0 | 30 | 25* | Pass |
| 4 | 2.5 | Yes | 5 | 0 | 30 | 25* | Pass |

*Based upon allowable infiltration limits

### Hydrostatic Infiltration Test Results

Infiltration tests were also performed on all four linings. The rigs were pressurised to 1 m for the 2-hour stabilisation period and then tested over a 30 minute period. The infiltration rate for repairs 1, 2, 3 and 4 was measured for 30 minutes. The measured values are shown in the table below. There was no observed leakage at all and no evidence of any other problems.

| | | | | Water | | | |
|---|---|---|---|---|---|---|---|
| | Seal wall | Fibreglass | | leakage | | Allowable | |
| Repair | thickness | Patch | Pressure | measurement | Duration | infiltration | Pass/ |
| No. | (mm) | used | (m) | (ml) | (minutes) | (ml) | Fail |
| 1 | 2.5 | Yes | 1 | 0 | 30 | 25* | Pass |
| 2 | 2.5 | Yes | 1 | 0 | 30 | 25* | Pass |
| 3 | 2.5 | Yes | 1 | 0 | 30 | 25* | Pass |
| 4 | 2.5 | Yes | 1 | 0 | 30 | 25* | Pass |

*Based upon allowable infiltration limits

| | | | | Water | | | |
|---|---|---|---|---|---|---|---|
| | Seal wall | Fibreglass | | leakage | | Allowable | |
| Repair | thickness | Patch | Pressure | measurement | Duration | infiltration | Pass/ |
| No. | (mm) | used | (m) | (ml) | (minutes) | (ml) | Fail |
| 1 | 2.5 | Yes | 2.5 | 0 | 30 | 25* | Pass |
| 2 | 2.5 | Yes | 2.5 | 0 | 30 | 25* | Pass |
| 3 | 2.5 | Yes | 2.5 | 0 | 30 | 25* | Pass |
| 4 | 2.5 | Yes | 2.5 | 0 | 30 | 25* | Pass |

*Based upon allowable infiltration limits

The table below shows that at 2.5 m head pressure all four linings also passed the test. There was no observed leakage or any evidence of any other problems.

| | | | | Water | | | |
|---|---|---|---|---|---|---|---|
| | Seal wall | Fibreglass | | leakage | | Allowable | |
| Repair | thickness | Patch | Pressure | measurement | Duration | infiltration | Pass/ |
| No. | (mm) | used | (m) | (ml) | (minutes) | (ml) | Fail |
| 1 | 2.5 | Yes | 5 | 0 | 30 | 25* | Pass |
| 2 | 2.5 | Yes | 5 | 0 | 30 | 25* | Pass |
| 3 | 2.5 | Yes | 5 | 0 | 30 | 25* | Pass |
| 4 | 2.5 | Yes | 5 | 0 | 30 | 25* | Pass |

*Based upon allowable infiltration limits

The table below shows that at 5 m head pressure all four linings passed the test. There was no observed leakage or any evidence of any other problems.

### Conclusions

All exfiltration and infiltration tests were passed. The key test parameter was to pass the 5 m applied head pressure during infiltration tests as that is a requirement of European Standard EN1610. Therefore the lining of the invention can claim testing in accordance with the EN1610 standard.

The lining of the invention has also been tested for leaktightness under external hydrostatic water pressure over a 6 month period.

Three localised circumferential slot defects having dimensions of 60 mm long (hoop direction) by 20 mm (length) wide in three pipes having diameters of 100 mm were repaired. These defects each represented a sewer in poor structural condition.

The test rig used was designed to allow external water pressure to be applied to a defective clay pipe and was assembled around the outside of the clay test pipe, two halves being screwed together to provide a water tight seal between the rig and the pipe. An inlet valve in the top of the rig enabled water to be pumped into a chamber above the pipe repair.

### Production of Test Samples

Three DN 100 SuperSleve clay pipes, each 1.8 m long, had a 60 mm long by 20 mm circumferential defect cut into the pipe wall at the pipe centres. The outside of the clay pipes were coated with varnish to prevent water permeating through the pipe wall during the hydrostatic test.

The prepared pipes were positioned in the test assembly so that the defect was at the centre of the 80 mm flange joint.

The defective clay pipe was installed within the test rig and a water header tank was positioned approximately 2.5 m above the test rig. Water was fed into the test rig to infiltrate through the defect at approximately 1 litre per minute before installation of the lining of the invention was allowed to commence. Once the defect was sealed by the lining of the invention product, the water level and hence subsequently pressure built up to a pressure of 2.5 m head, which was held for the duration of the installation process.

### Test Procedure

### Short Term Procedure:

The procedure for short term testing was as follows:
1. the test rig was pressured to 10 m head (1 bar) for a period of 2 hours, and;
2. subsequently, any water infiltration through the repaired defect was collected and measured over the following 30 minutes.

### Long Term Procedure:

The procedure for long term testing was as follows:

A cyclic external hydrostatic pressure (between 1 m and a maximum of 5 m head) was applied which varied throughout the day over a 6-month period simultaneously on all three repairs.

During the first month the repair was under cyclic pressure (i.e. ‘wet’), during the second month there was no hydrostatic pressure (e.g. to simulate a lower ground water table during summer months). This was then followed by 1 month ‘wet’, 2 months ‘damp’ and 1 month ‘wet’. This wet/damp cycle was intended to simulate seasonal changes in ground water level.

During the ‘damp’ period the test rig was drained of water, a stopper was inserted into the lowest end of the clay pipe and a little water was poured into the clay pipe so that there was some standing water, keeping the patch repair damp.

During testing the repaired pipes were tilted and infiltrating water was collected from the lower pipe end(s) and measured/recorded using rain gauges.

After the repairs had been installed and were ready for hydrostatic testing, all the test rigs were set on an incline so that any infiltration via the repair would run to the lower end of the pipe. A tipping bucket rain gauge was placed under each of the repaired pipes so that any infiltrating water would be collected and logged by the rain gauge and data logger.

During “wet” testing, the hydrostatic pressure applied followed a daily cycle as shown in the table below.

| | | Approximate duration | |
|---|---|---|---|
| Start time | To | to reach head (mins) | Head (m) |
| 0.00 | 9.00 | — | 1 |
| 9.00 | 9.02 | 2 | 2.5 |
| 9.58 | 10.00 | 5 | 5 |
| 16.00 | 16.01 | 1 | 2.5 |
| 17.00 | 23.59 | 1 | 1 |

The linings used in the repairs consisted of the following components:
“Cartyrecumb” rubber sleeves with a wall thickness of 3 mm.
Araldite Rapid adhesive.
Glass fibre tissues 25-30 grams per m².

Periodically, about 100 ml of water was deliberately tipped into the rain gauges so that a ‘calibration spike’ appeared on the infiltration graphs. This is common in such tests where there is minor or no visible infiltration as proof that the logger was recording throughout the test period. These spikes can be seen in FIGS. 4-12.

The infiltration and ‘calibration spike’ volumes were measured and logged in 30 minute time periods. The infiltration graphs in FIGS. 4-12 show the volume of infiltration in ml/hour and hence infiltration rates and ‘calibration spike’ columns appear as 200 ml per hour.

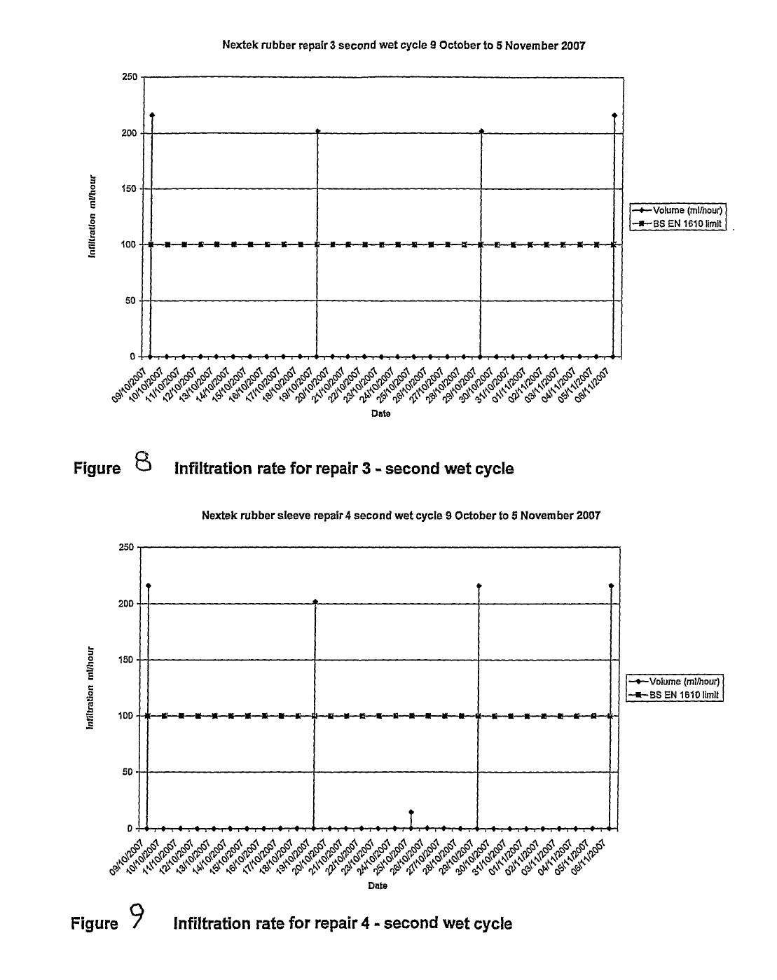

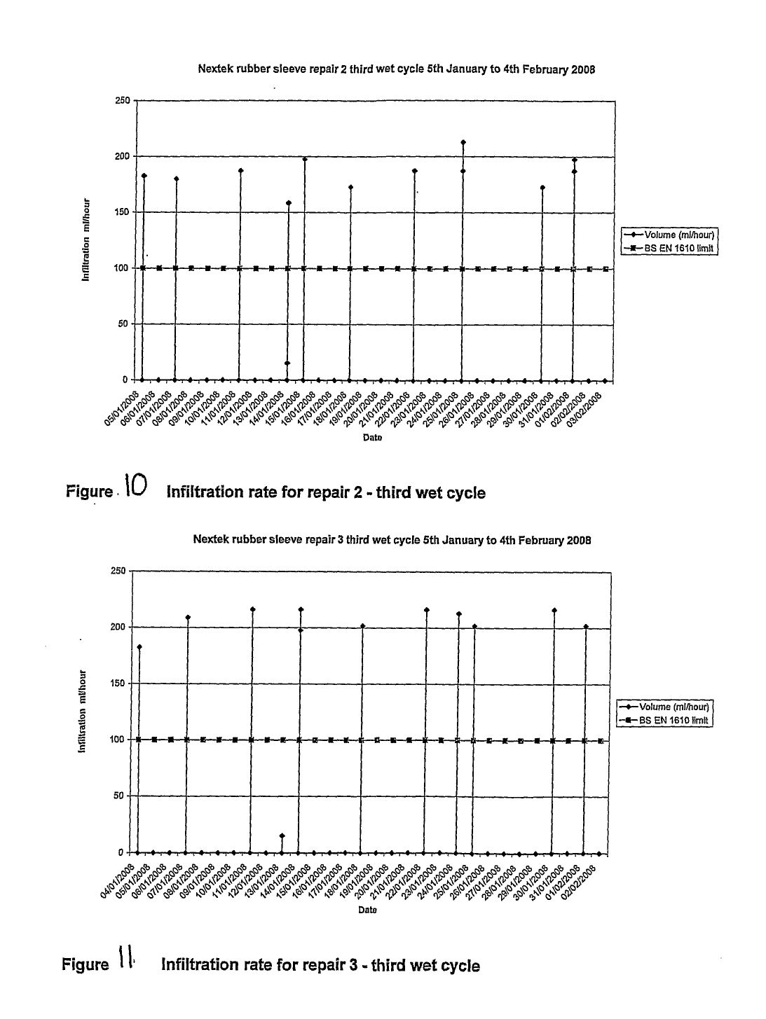

During the second wet cycle repairs 2 and 4 did show a recorded “infiltration” on 19 Oct. 2007 and 24 Oct. 2007 respectively (see FIGS. 7 and 9). Both events were a single tip of the rain gauge bucket and are attributed to physical movement of the rain gauge rather than infiltration via the repair.

On the third wet cycle there are spikes for each of repairs 2-4 on 14, 13 and 20 Jan. 2008, respectively (see FIGS. 10-12). As with those recorded during the second wet cycle, the measurements are attributed to physical movement of the rain gauge rather than infiltration via the repair. An addition calibration spike is visible for 15 Jan. 2008; however this was undertaken as a demonstration of the test procedure and equipment configuration and does not constitute infiltration.

### Pass/Failure Criteria

The repairs are deemed to have passed the above test if the infiltration rate is equivalent to or lower than the infiltration limit rate stated in Sewers for Adoption 5^{th Edition (i.e.} 500 ml/m diameter/m length over a 30 minute period at 5 m hydrostatic pressure, the repair length being taken as 1 m) which is based upon BS EN 1610.

The lining of the present invention passed the test and showed no evidence of any infiltration during any of the wet cycles.

It is of course to be understood that the invention is not intended to be restricted to the details of the above embodiments which are described by way of example only.

1. A polymeric composite material comprising at least one polymer material and a quantity of an adhesive component, wherein the adhesive component comprises a reinforcement material.

2. A composite material according to claim 1, wherein the reinforcement material is a fibrous reinforcement material.

3. A composite material according to claim 2, wherein the fibrous reinforcement material comprises glass fibre.

4. A composite material according to claim 1, wherein the reinforcement material is particulate filler, or a reinforcement material selected from carbon fibre, Kevlar, nylon or polyester.

5. A composite material according to claim 1, further comprising at least one filler, said filler having a mean particle size distribution in the range of from about 10 nm to about 600 microns.

6. A composite material according to claim 5 wherein the filler comprises rubber.

7. A composite material according to claim 6 wherein the rubber comprises recycled rubber.

8. A composite material according to claim 7, wherein the recycled rubber comprises rubber crumb from car tyres.

9. A composite material according to claim 5 wherein the filler has a mean particle size distribution in the range of from about 10 nm to about 500 microns.

10. A composite material according to claim 5, wherein the filler is present in a range of discrete particle sizes.

11. A composite material according to claim 10, wherein the particles are present in two discrete mean sizes in the composite material, the ratio of the relative amounts of the two mean particle sizes being from about 5:1 to about 1:5.

12. A composite material according to claim 5, wherein the surface chemistry of the filler is modified via oxidation.

13. A composite material according to claim 5, wherein the polymer material and the filler are present in the polymeric composite material in a ratio of from about 70:30 to about 30:70.

14. A composite material according to claim 1, wherein said polymer material is selected from any of the following either alone or in combination: low density polyethylene, linear low density polyethylene, poly(ethylene-co-vinyl acetate), high density polyethylene, plasticised PVC, ethylene-propylene copolymers, ethylene-propylene diene monomer, polyisoprene, polychlorprene, polybutadiene, and copolymers of polybutadiene.

15. (canceled)

16. A lining comprising a composite material according to claim 1.

17. A lining according to claim 16, wherein the lining has a modulus in the range from about 1 MPa to about 3 MPa.

18. A lining according to claim 16, wherein the lining has a wall thickness in the range from about 1 to about 5 mm.

19. A lining according to claim 18, wherein the wall thickness is in the range from about 2 to about 3 mm.

20. A lining according to claim 16, wherein the internal and/or external surface of the lining is coated with a further polymer material.

21. A lining according to claim 20, wherein the further polymer material is selected from low density polyethylene, linear low density polyethylene, poly(ethylene-co-vinyl acetate), high density polyethylene, plasticised polyvinyl chloride, ethylene-propylene copolymers, ethylene-propylene diene monomer, polyisoprene, polychlorprene, polybutadiene, and copolymers of polybutadiene, or a combination of any two or more thereof.

22-31. (canceled)
